(19) United States
(12) Patent Application Publication
(10) Pub. No.: US 2025/0229194 A1
(43) Pub. Date: Jul. 17, 2025

(54) WATER SPRAY DEVICE

(71) Applicant: BESTWAY INFLATABLES & MATERIAL CORP., Shanghai (CN)

(72) Inventor: Qiang ZHU, Shanghai (CN)

(21) Appl. No.: 19/015,312

(22) Filed: Jan. 9, 2025

(30) Foreign Application Priority Data
Jan. 11, 2024 (CN) 202420067701.6

(51) Int. Cl. A63H 29/14

(52) U.S. Cl. CPC A63H 29/14

(57) ABSTRACT

A water spray device includes a device body defining at least one first water flow channel, at least one water spray valve including a water spray nozzle, the water spray nozzle including a second water flow channel, and at least one floating ball arranged adjacent to the water spray nozzle and adapted to be supported by water spouted from the second water flow channel of the water spray nozzle. The water spray nozzle is adapted to be adjusted to orient the second water flow channel in a vertical direction, the water spray valve is mounted to the device body, and the second water flow channel is in fluid communication with the first water flow channel.

### CROSS-REFERENCE TO RELATED APPLICATIONS

This application claims the benefit of Chinese Utility Model No. 202420067701.6, filed Jan. 12, 2024, the entire contents of which are hereby incorporated by reference in their entirety.

### TECHNICAL FIELD

The present application relates to toys, and in particular, to a water spray device.

### BACKGROUND

Water toys are often used by children and other individuals to cool down during the summer. In particular, water spray mats may be used by individuals to cool down on warm days, with traditional water spray mats being used to spout water through a number of water spray holes and splash over a user. In some embodiments, traditional water spray mats may be provided with a floating ball. As described herein, water spouted from the water spray holes may form a water jet that supports the floating ball to be in a suspended state. However, when the water spray mat is positioned on a slope the water jet is in an inclined state, such that the water jet is unable to support the floating ball. Accordingly, a need exists for a water spray mat that is capable of supporting a floating ball while positioned on a slope (e.g., incline or decline).

### SUMMARY

The present application is directed to a water spray device. The water spray device includes a device body defining at least one first water flow channel, at least one water spray valve including a water spray nozzle, the water spray nozzle defining a second water flow channel, and at least one floating ball arranged adjacent to the water spray nozzle and adapted to be supported by water spouted from the second water flow channel of the water spray nozzle. The water spray nozzle is adapted to be adjusted to orient the second water flow channel in a vertical direction, the water spray valve is mounted to the device body, and the second water flow channel is in fluid communication with the first water flow channel. In an embodiment, the water spray valve further includes a valve seat that is provided with a valve chamber and a water intake port in communication with the valve chamber, and a first end of the valve chamber is provided with an opening, and the water intake port is located at a second end of the valve chamber that is offset from the first end.

In an embodiment, the water spray nozzle includes an assembly portion and a water spray rod extending from the assembly portion, and the second water flow channel extends through the assembly portion and the water spray rod, the assembly portion is movably arranged inside the valve chamber, the water spray rod extends through the opening to the outside of the valve chamber, and the second water flow channel is in communication with the water intake port, and the first water flow channel is in communication with the water intake port.

In an embodiment, the assembly portion is configured in a spherical shape and is rotatably assembled in the valve chamber.

In an embodiment, a sealing ring is provided around the water intake port in the valve chamber, and the assembly portion forms a seal with the sealing ring.

In an embodiment, the water spray valve further includes a bonnet having a cambered surface matching the spherical shape of the assembly portion and an assembly port corresponding to the opening. The bonnet is mounted to the valve seat, the cambered surface fits with the assembly portion to constrain the assembly portion within the valve chamber, and the water spray rod extends through the assembly port.

In an embodiment, one of the bonnet and the valve seat is provided with a plurality of elastic claws, and the other of the bonnet and the valve seat is provided with a plurality of engagement grooves matching the elastic claws.

In an embodiment, the plurality of elastic claws are adapted to be snap-fitted into the corresponding engagement grooves such that the bonnet is fixed mounted to the valve seat.

In an embodiment, the bonnet and the valve seat are fixedly connected together by a screw.

In an embodiment, the valve seat includes a valve seat body and a valve seat sleeve connected to an outer surface of the valve seat body, the valve chamber is formed in the valve seat body, and the valve seat sleeve and the device body are connected together to form a valve seat sleeve seal.

In an embodiment, the valve seat sleeve is provided with an extension extending away from the valve seat body, and the extension and the device body are connected together to form an extension seal.

In an embodiment, the first water flow channel is provided with at least one water holding chamber, the water spray valve is mounted to a top wall of the water holding chamber in a sealing manner, and the second water flow channel is in communication with the inside of the water holding chamber.

In an embodiment, the water holding chamber protrudes upwardly from the device body.

In an embodiment, the device body includes a base and an air chamber protruding upwards from the base, and the water spray valve is mounted to a top wall of the air chamber in a sealing manner, and the first water flow channel extends into the air chamber and is in communication with the second water flow channel of the water spray valve.

In an embodiment, the base is configured as a water chamber adapted to be filled with water, and the water chamber is separated from the air chamber.

In an embodiment, the water spray device is one of a water spray mat, a water spray column and a pool.

In another embodiment, a pool is disclosed. The pool includes a pool body having a base, a vertical barrier wall arranged along a circumferential edge of the base, an air chamber protruding upwardly from the base, and a water spray device. The water spray device includes a device body defining at least one first water flow channel, at least one water spray valve comprising a water spray nozzle, the water spray nozzle defining a second water flow channel, and at least one floating ball arranged adjacent to the water spray nozzle and adapted to be supported by water spouted from the second water flow channel of the water spray nozzle. The water spray nozzle is adapted to be adjusted to orient the second water flow channel in a vertical direction, the water spray valve is mounted to the device body, and the second water flow channel is in fluid communication with the first water flow channel.

In an embodiment, the water spray valve further includes a valve seat that is provided with a valve chamber and a water intake port in communication with the valve chamber, a first end of the valve chamber is provided with an opening, and the water intake port is located at a second end of the valve chamber that is offset from the first end.

In an embodiment, the water spray nozzle further comprises an assembly portion and a water spray rod extending from the assembly portion, and the second water flow channel extends through the assembly portion and the water spray rod, the assembly portion is movably arranged inside the valve chamber, the water spray rod extends through the opening to the outside of the valve chamber, the second water flow channel is in communication with the water intake port, and the first water flow channel is in communication with the water intake port.

In some embodiments, a water spray column is disclosed. The water spray column includes a base, an air chamber located above the base, a spacer that separates the base and the air chamber, and a water spray device. The water spray device includes a device body defining at least one first water flow channel, at least one water spray valve comprising a water spray nozzle, the water spray nozzle defining a second water flow channel, and at least one floating ball arranged adjacent to the water spray nozzle and adapted to be supported by water spouted from the second water flow channel of the water spray nozzle. The water spray nozzle is adapted to be adjusted to orient the second water flow channel in a vertical direction, the water spray valve is mounted to the device body, and the second water flow channel is in fluid communication with the first water flow channel.

The beneficial effects of the present application are as follows. The water spray device of the present application includes the water spray valve, and the water spray nozzle includes a second water flow channel. The water spray nozzle is adapted to be adjusted such that the second water flow channel is oriented in a vertical direction. In this way, when the water spray device is arranged on the horizontal ground or on a slope, the second water flow channel of the water spray nozzle can be adjusted to be oriented in the vertical direction such that water spouted from the second water flow channel of the water spray nozzle is oriented in the vertical direction and supports the floating ball.

### BRIEF DESCRIPTION OF THE DRAWINGS

Other features and advantages of the present disclosure will be understood from the following embodiments described in detail herein and with reference to the accompanying drawings, in which like reference numerals represent the same or similar components.

FIG. 1 schematically depicts a water spray device, according to one or more embodiments shown and described herein;

FIG. 2 schematically depicts an enlarged view of a water holding chamber of the water spray device of FIG. 1, according to one or more embodiments shown and described herein;

FIG. 3 schematically depicts the water spray device of FIG. 1 positioned on a slope, according to one or more embodiments shown and described herein;

FIG. 4 schematically depicts an enlarged view of a water holding chamber of the water spray device of FIG. 3, according to one or more embodiments shown and described herein;

FIG. 5 schematically depicts a water spray valve of the water spray device of FIG. 1, according to one or more embodiments shown and described herein;

FIG. 6 schematically depicts a cross-sectional view of the water spray valve of FIG. 5 with a water spray nozzle being oriented in a vertical direction, according to one or more embodiments shown and described herein;

FIG. 7 schematically depicts an exploded view of the water spray valve of FIG. 5, according to one or more embodiments shown and described herein;

FIG. 8 schematically depicts the water spray valve shown in FIG. 5, with the water spray valve being tilted and the water spray nozzle being adjusted to be oriented in a vertical direction, according to one or more embodiments shown and described herein;

FIG. 9 schematically depicts the water spray valve shown in FIG. 5, with the water spray valve being tilted and the water spray nozzle being adjusted to be oriented in a vertical direction, according to one or more embodiments shown and described herein;

FIG. 10 schematically depicts an exploded view of another embodiment of a water spray valve, according to one or more embodiments shown and described herein;

FIG. 11 schematically depicts a cross-sectional view of the water spray valve of FIG. 10, according to one or more embodiments shown and described herein;

FIG. 12 schematically depicts another embodiment of a water spray device, according to one or more embodiments shown and described herein;

FIG. 13 schematically depicts the water spray device of FIG. 12 positioned on a slope, according to one or more embodiments shown and described herein; and

FIG. 14 schematically depicts another embodiment of a water spray device, according to one or more embodiments shown and described herein.

Other features and advantages of the present disclosure will be understood from the following embodiments described in detail herein and with reference to the accompanying drawings, in which like reference numerals represent the same or similar components.

### DETAILED DESCRIPTION

To make the objectives, technical solutions, and advantages of the present disclosure more clear, the technical solutions of the present disclosure will be clearly and completely described with reference to specific embodiments of the present disclosure and corresponding figures. It should be appreciated that the embodiments as described are only some rather than all of the embodiments of the present disclosure. All other embodiments obtained by those of ordinary skill in the art based on the embodiments of the present disclosure without creative efforts shall fall within the scope of protection of the present disclosure.

In the present disclosure, the term “vertical direction” refers to a direction generally perpendicular to the horizontal plane. Similarly, the term “horizontal direction” refers to a direction generally parallel to the horizontal plane. In the embodiments described herein, it should be further understood that the term “up” refers to a direction away from the ground in the vertical direction and the term “down” refers to a direction towards the ground in the vertical direction.

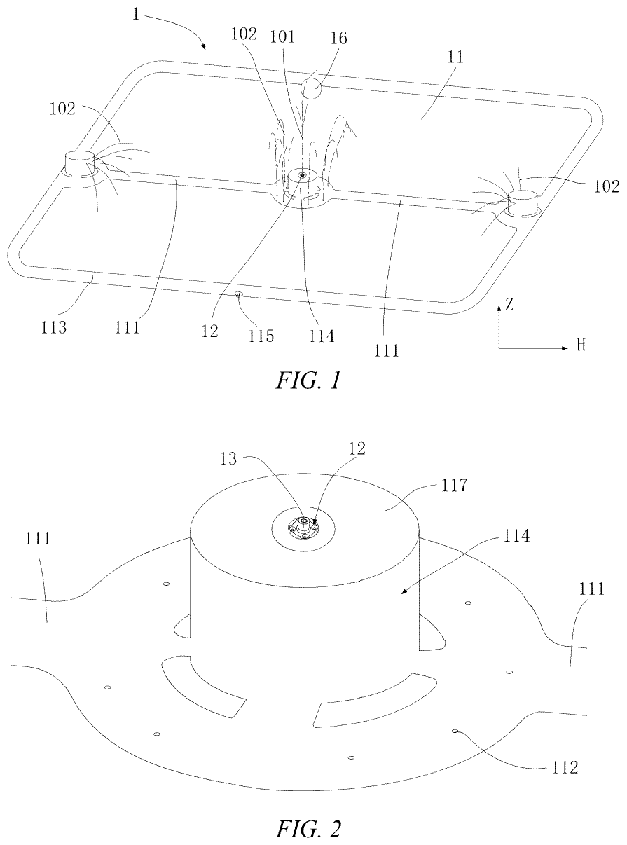

Turning now to the drawings, FIG. 1 schematically depicts a water spray device 100. As shown in FIG. 1, the water spray device 100 may be implemented as a water spray mat 1. In these embodiments, the water spray mat 1 may include a water spray mat body 11 (e.g., a device body), a floating ball 16, and a water spray valve 12 that is mounted to the water spray mat body 11, with the water spray mat body 11 being provided with and/or defining a first water flow channel 111.

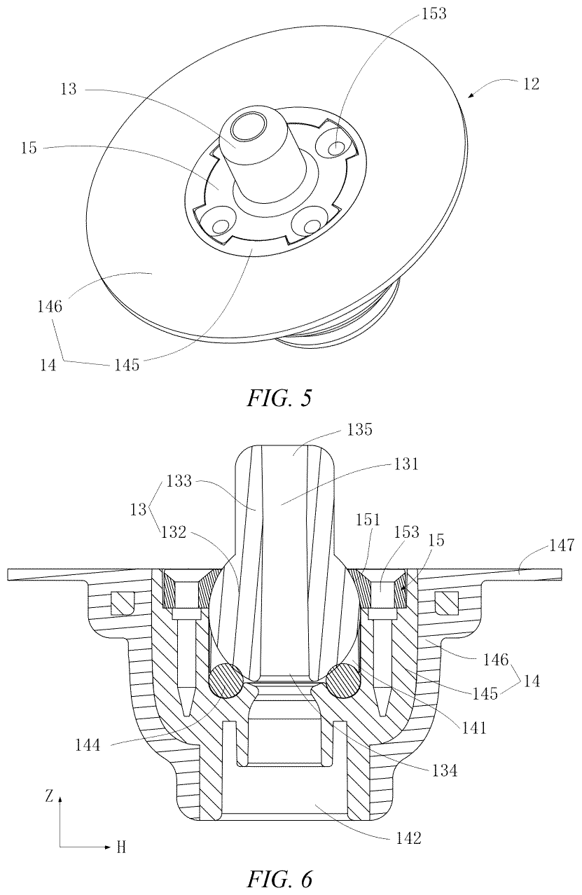

In the embodiments described herein, the water spray valve 12 may further include a water spray nozzle 13 (e.g., as depicted in FIGS. 5 and 6). The water spray nozzle 13 may be provided with and/or define a second water flow channel 131 in an axially penetrating manner (e.g., the second water flow channel 131 may extend through and/or penetrate the water spray nozzle 13 in an axial direction). The water spray nozzle 13 may be further adjustable such that the second water flow channel 131 is oriented in a vertical direction Z. As shown in the appended figures, Z and H directions are, respectively, the vertical and the horizontal directions considering an absolute reference system of the Earth, with the H direction parallel to the horizontal plane, while the Z direction is vertical, therefore perpendicular, to the H direction, therefore to the horizontal plane.

In these embodiments, after the water spray valve 12 is mounted to the water spray mat body 11, the second water flow channel 131 may be in communication with the first water flow channel 111. For example, the first water flow channel 111 and the second water flow channel 131 may be in fluid communication, such that a fluid may pass between the first water flow channel 111 and the second water flow channel 131. Furthermore, as illustrated in FIGS. 1 and 2, the floating ball 16 may be arranged corresponding to the water spray nozzle 13. For example, the floating ball 16 may be positioned adjacent the water spray nozzle 13, such that the floating ball 16 may be supported and/or suspended by a fluid (e.g., water) that is expelled from the second water flow channel 131 of the water spray nozzle 13. More particularly, it should be appreciated that the floating ball 16 maybe supported by a fluid that is spouted upwardly in a vertical direction from the second water flow channel 131 of the water spray nozzle 13.

Referring still to FIGS. 1 and 2, when the water spray mat 1 is in use, the first water flow channel 111 may be in communication with an external water source (e.g., a faucet), which may provide water to the water spray mat 1. In these embodiments, water from the external water source may flow into the water spray valve 12 through the first water flow channel 111, at which point the water may be spouted from the water spray nozzle 13 of the water spray valve 12, such that a water spray function of the water spray mat 1 is realized. As shown most clearly in FIG. 1, when the water spray mat 1 is arranged on a horizontal ground (e.g., a flat plane), the water spray nozzle 13 of the water spray valve 12 is oriented in the vertical direction Z, considered in an absolute Earth's reference system. Considering the water spray mat 1 lying down on a horizontal ground, the vertical direction Z is perpendicular to the flat plane of the water spray mat 1 and, therefore, also perpendicular to the horizontal ground. Accordingly, in these embodiments, the water spouted from the water spray nozzle 13 forms a first water jet 101 that extends vertically upwards from the water spray nozzle 13. As illustrated in FIG. 1, the first water jet 101 may support the corresponding floating ball 16 to allow the floating ball 16 to remain in a suspended state when the water spray mat 1 is in use.

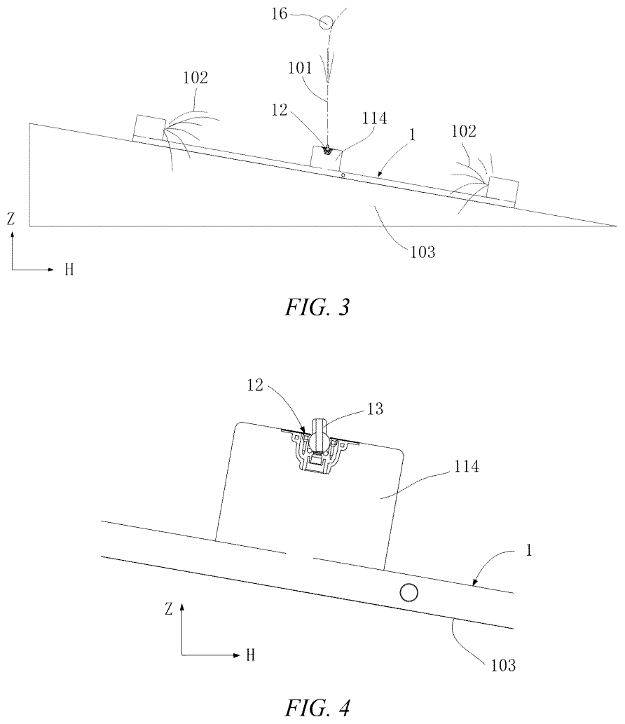

Referring now to FIG. 3, it should be appreciated that, when the water spray mat 1 is arranged on a slope 103 (e.g., as shown in FIG. 4), the water spray nozzle 13 may be adjusted such that the water spray nozzle 13 is oriented in the vertical direction Z. In other words, considering an absolute Earth's reference system, the vertical direction Z, and therefore also the direction of the water spray nozzle 13, results perpendicular to a horizontal plane (sec the H horizontal direction). Since the water spray mat 1 is placed on a plane inclined of an angle a with respect to an absolute horizontal ground, the vertical direction Z forms the same angle a with the line perpendicular to the inclined plane of which lays the water spray mat 1. Accordingly, in these embodiments, the water spouted from the water spray nozzle 13 may form the first water jet 101 that extends in the vertically upward direction even when the water spray mat 1 is positioned on the slope 103. For example, by adjusting the water spray nozzle 13 as illustrated in FIGS. 3 and 4, it may be possible to ensure that the first water jet 101 extends in the vertical direction, such that the first water jet 101 can still support the floating ball 16 to allow the floating ball 16 to remain in the suspended state even when the water spray mat 1 is positioned on the slope 103. In this way, regardless of whether the water spray mat 1 is arranged on the horizontal ground (e.g., flat plane) or on the slope 103, the first water jet 101 spouted from the water spray nozzle 13 can be oriented in the vertical direction Z and support the floating ball 16. It should be appreciated that the adjustment of the water spray mat 1 to compensate for a slope on which the water spray mat 1 is positioned may improve the enjoyment of the water spray mat 1 and is conducive to attracting children to play on the water spray mat 1.

Referring still to FIGS. 3 and 4, it should be further understood that when the floating ball 16 is not in use, the orientation of the water spray nozzle 13 may be adjusted as needed to change the direction of the first water jet 101. For example, in embodiments in which the floating ball 16 is not in use, the water spray nozzle 13 may not be adjusted, as the water spray nozzle 13 is not used to support the floating ball in the suspended state. It should be further understood that, in some embodiments, the water spray mat 1 may also be used without supplying water to the first water flow channel 111, such that the water spray mat 1 is used as an ordinary mat.

It should be further appreciated that, in some embodiments, the floating ball 16 may be a light weight floating ball, such as a floating ball having a weight, for example, between 5 g and 8 g. Accordingly, in these embodiments, the floating ball 16 may have a weight that allows the floating ball 16 to be supported by the first water jet 101. For example, in the embodiments described herein, the floating ball 16 may be an ocean ball. Such a floating ball 16 may have a light (e.g., small) weight, and will not cause harm to a user if knocked out of the suspended state, which is conducive to improving the safety of the water spray mat 1. In addition, the ocean ball may also be conducive to further improving the enjoyment of the water spray mat 1.

Referring again to FIG. 1, it should be appreciated that, in some embodiments, the water spray mat body 11 may have a generally square shape. However, it should be further understood that the water spray mat body 11 may take any other shape, such as a generally circular shape, without departing from the scope of the present disclosure. A suction cup (not shown in the figure) or a rough structure (not shown in the figure) may also be provided on a bottom surface of the water spray mat body 11 in contact with the ground, so as to improve the stability of the water spray mat 1 and avoid danger caused by accidental displacement of the water spray mat body 11.

Referring still to FIG. 1, the first water flow channel 111 may be further provided with a water holding chamber 114. For example, the water holding chamber 114 may be positioned in the middle of the water spray mat body 11. The water spray valve 12 may be mounted to a top wall 117 of the water holding chamber 114 (e.g., as shown in FIG. 2) in a sealing manner, such that contact between the water spray valve 12 and the water holding chamber 114 forms a seal between the water spray valve 12 and the water holding chamber 114. Furthermore, in these embodiments, the second water flow channel 131 may be in communication (e.g., fluid communication) with the inside of the water holding chamber 114. Accordingly, when the water spray mat 1 is in use, water enters the water holding chamber 114 through the first water flow channel 111. After the water holding chamber 114 is filled with water, the water is spouted through the water spray valve 12 to form the first water jet 101, as has been described in detail herein. Accordingly, it should be appreciated that, in these embodiments, the first water jet 101 may not be easily interrupted and can thus stably support the floating ball 16.

In addition, as illustrated in FIG. 1, the water holding chamber 114 may protrude upwardly (e.g., in the +Z-direction as depicted in the coordinate axis of FIG. 1) from the water spray mat body 11. In these embodiments, when the water spray mat 1 is in use, it is possible to prevent the water accumulated on the water spray mat body 11 from flooding the water spray valve 12 and thus affecting the water spray. For example, the water holding chamber 114 may be sized and/or shaped to accommodate a predetermined volume of fluid (e.g., water) such that the water accumulated on the water spray mat body 11 does not impact water spray. For example, in these embodiments, the water holding chamber size may be between 3 cm and 5 cm.

In other embodiments, a plurality of water holding chambers 114 may be provided on the first water flow channel 111, and each water holding chamber 114 is provided with a water spray valve 12. In this way, when the water spray mat 1 is in use, multiple first water jets 101 may be generated at the same time to simultaneously support multiple floating balls 16, which further improves the enjoyment of the water spray mat 1. Although the figures provided herein depict the water spray mat 1 as having a single water holding chamber 114, it should be appreciated that the water spray mat 1 may include any number of water holding chambers (and in turn, water spray valves 12 and floating balls 16) without departing from the scope of the present disclosure.

Referring still to FIG. 1, it should be appreciated that the water spray mat 1 may include at least two first water flow channels 111. In these embodiments, the two first water flow channels 111 extend from a circumferential edge of the water spray mat body 11 to the middle of the water spray mat body 11 and converge in the middle of the water spray mat body 11. As illustrated in FIG. 1, the water holding chamber 114 may be arranged at a position and/or location where the two first water flow channels 111 converge. Based on this structure, both of the first water flow channels 111 supply water to the water holding chamber 114, such that, even if one of the first water flow channels 111 is cut off (e.g., damaged or stepped on by a child), the other first water flow channel 111 may continue to supply water to the water holding chamber 114 and avoid interruption of the first water jet 101. Furthermore, although the water spray mat 1 of FIG. 1 is depicted as including at least two first water flow channel 111, it should be understood that the water spray mat 1 may include any number of first water flow channels 111 without departing from the scope of the present disclosure.

As further depicted in FIG. 1, a third water flow channel 113 may be provided along the circumferential edge of the water spray mat body 11. In these embodiments, a water source connection port 115 may be provided on the third water flow channel 113, and the first water flow channels 111 (e.g., the two first water flow channels 111) are in communication with the third water flow channel 113. When the water spray mat 1 is in use, the water source connection port 115 may be in communication (e.g., fluid communication) with an external water source to supply water to the third water flow channel 113 and the first water flow channel 111. As water is supplied to the third water flow channel 113 (e.g., via the water source connection port 115), the third water flow channel 113 may be filled with water, such that the third water flow channel 113 may bulge relative to the water spray mat body 11. In these embodiments, the “bulged” third water flow channel 113 may form a dam, such that the splashed water (e.g., dispensed from the water spray nozzle or otherwise) may accumulate on the water spray mat body 11 which is also conducive to preventing water from flowing to the outside of the water spray mat 1 and thus causing inconvenience to the user.

In the embodiments described herein, it should be further appreciated that the water spray holes 112 may be provided in the first water flow channel 111 and offset from the water holding chamber 114. Furthermore, in other embodiments, the water spray holes 112 may be provided at the convergence of the first water flow channel 111 and the third water flow channel 113. Accordingly, when the water spray mat 1 is in use, the water spray valve 12 may spout water to form the first water jet 101, and the water spray holes 112 can spout water to form second water jets 102. In these embodiments, at least a portion of the second water jets 102 surround the first water jet 101 to keep the floating ball 16 suspended. It should be appreciated that the formation of the second water jets 102 is conducive to further improving the enjoyment of the water spray mat 1. Furthermore, it should be understood that water spray valves 12 can be provided at the water spray holes 112, while in some embodiments, no water spray valve 12 may be provided, without departing from the scope of the present disclosure.

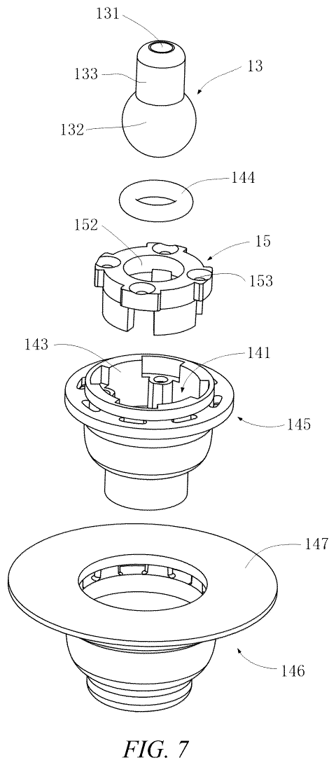

Referring now to FIGS. 6 and 7, the water spray valve 12 will be described in additional detail. For example, as shown in FIG. 6, the water spray valve 12 may include a valve seat 14. The valve seat 14 may be provided with a valve chamber 141 and a water intake port 142 in communication (e.g., fluid communication) with the valve chamber 141. A first end of the valve chamber 141 may be provided with an opening 143 (as shown in FIG. 7), and the water intake port 142 may be located at a second end of the valve chamber 141 that is offset from the first end.

In an embodiment, the valve seat 14 may have a generally cylindrical shape. Accordingly, at least one of the axial end portions of the valve seat 14 may be configured as the opening 143, and the other of the axial end portions of the valve seat 14 may be provided with the water intake port 142. For example, in these embodiments, the opening 143 may be directly aligned to the water intake port 142 in an axial direction of the valve seat 14. It should be understood that, in other embodiments, the valve seat 14 may also be in other shapes (e.g., square, rectangular, etc.) without departing from the scope of the present disclosure. Similarly, in some embodiments, the opening 143 may not be aligned to the water intake port 142 without departing from the scope of the present disclosure.

Referring still to FIG. 6, the water spray nozzle 13 may also include an assembly portion 132 and a water spray rod 133 extending from the assembly portion 132. In these embodiments, the second water flow channel 131 extends through the assembly portion 132 and the water spray rod 133, and has a first opening 134 in the assembly portion 132 and a second opening 135 in the water spray rod 133. The assembly portion 132 may be movably arranged inside the valve chamber 141, and the water spray rod 133 may extend through the opening 143 to the outside of the valve chamber 141.

As further depicted in FIG. 6, the first opening 134 of the second water flow channel 131 may be in communication (e.g., fluid communication) with the water intake port 142. In these embodiments, after the water spray valve 12 is mounted to the water holding chamber 114, the water intake port 142 may be in communication with the inside of the water holding chamber 114, such that the water in the water holding chamber 114 may flow into the second water flow channel 131 through the water intake port 142 and, in turn, be spouted from the second opening 135 in the water spray rod 133. In these embodiments, the user may conveniently push or pull the water spray rod 133, and the assembly portion 132 may correspondingly rotate within the valve chamber 141, so as to adjust the orientation of the water spray rod 133 and, in turn, adjust the orientation of the second water flow channel 131. It should be noted that when the assembly portion 132 moves within the valve chamber 141, the first opening 134 of the second water flow channel 131 remains in communication with the water intake port 142 to avoid interruption of the first water jet 101.

In some embodiments, such as those depicted in FIGS. 6 and 7, the assembly portion 132 may have a spherical shape and may be rotatably assembled in the valve chamber 141. In these embodiments, it should be appreciated that the assembly portion 132 may be “rotatably assembled” in the valve chamber 141 such that the assembly portion 132 is capable of rotating within the valve chamber 141, as has been described herein.

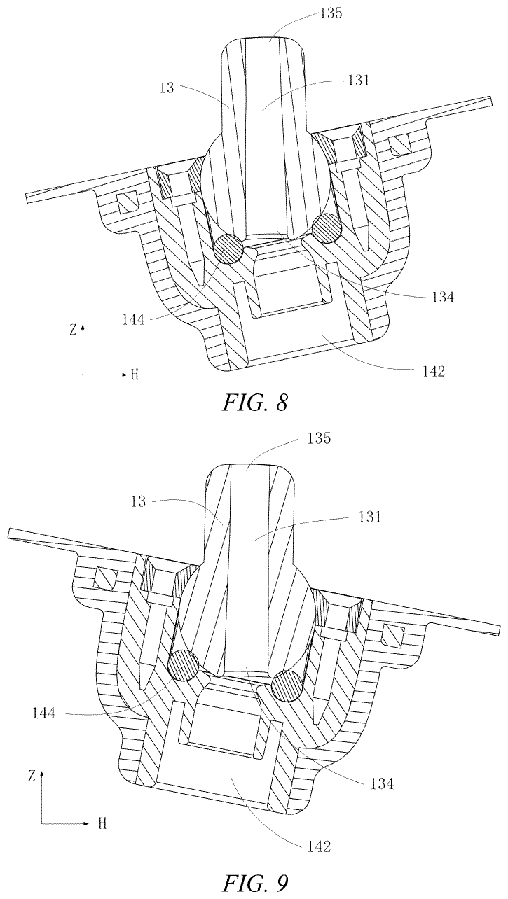

As further depicted in FIGS. 6 and 7, the assembly portion 132 may form a spherical connection with the valve seat 14 such that the assembly portion 132 having the spherical shape may be limited within the valve chamber 141 and can rotate in various directions, which is conducive to achieving universal adjustment of the orientation of the water spray rod 133 and the orientation of the second water flow channel 131. For example, as shown in FIGS. 8 and 9, the water spray rod 133 and the second water flow channel 131 may be adjusted such that the water spray rod may be positioned in any desired direction.

In the embodiments described herein, the valve chamber 141 may be configured as a ball socket that matches the spherical assembly portion 132. In other embodiments, the valve chamber 141 may not be a ball socket, but may be in other shapes (e.g., a cylindrical groove, etc.), as long as the spherical assembly portion 132 may freely rotate within the valve chamber 141. In addition, it should be appreciated that the assembly portion 132 and the valve seat 14 may also be connected by means of other types of universal connection structures without departing from the scope of the present disclosure.

Referring still to FIGS. 6 and 7, a scaling ring 144 may be arranged around the water intake port 142 in the valve chamber 141. In these embodiments, the assembly portion 132 may be in contact with the sealing ring 144 in a sealing manner, such that a seal is formed between the assembly portion 132 and the sealing ring 144 when the assembly portion 132 and the sealing ring 144 are in contact. As further illustrated in FIGS. 6 and 7, the second water flow channel 131 and the water intake port 142 may form a closed water flow path by means of the sealing ring 144, so as to prevent water from leaking from the joint between the second water flow channel 131 and the water intake port 142. It should be appreciated that, when the orientation of the water spray rod 133 is adjusted, the assembly portion 132 may remain in contact with the sealing ring 144 in a sealing manner, and the first opening 134 of the second water flow channel 131 is within the range of the sealing ring 144, so as to prevent water from leaking from the joint between the second water flow channel 131 and the water intake port 142.

In the embodiments described herein, it should be further appreciated that the sealing ring 144 may dampen the movement of the assembly portion 132. In these embodiments, when the orientation of the water spray rod 133 is adjusted, the damping (e.g., provided by the sealing ring 144) may enable the water spray rod 133 to stop in the vertical direction Z (or other desired directions).

Referring still to FIGS. 6 and 7, the water spray valve 12 may further include a bonnet 15. In particular, the bonnet 15 may be provided with a cambered surface 151 that matches the spherical shape of the assembly portion 132 and an assembly port 152 corresponding to the opening 143. As shown most clearly in FIG. 6, the bonnet 15 may be mounted to the valve seat 14.

As further illustrated in FIGS. 6 and 7, the cambered surface 151 and the assembly portion 132 may fit together to constrain the assembly portion 132 within the valve chamber 141. In these embodiments, the assembly port 152 may be aligned with the opening 143 of the valve chamber 141, so as to allow the water spray rod 133 to extend through the assembly port 152 and the opening 143. It should be further appreciated that, when the orientation of the water spray rod 133 is adjusted, the bonnet 15 can prevent the assembly portion 132 from disengaging from the inside of the valve chamber 141. The bonnet 15 may also exert pressure from the assembly portion 132 towards the sealing ring 144 to keep the assembly portion 132 in close contact with the sealing ring 144. In addition, and has been described in detail herein, the bonnet 15 may dampen the movement of the assembly portion 132, which also facilitates the water spray rod 133 to stop to be in the vertical direction Z (or in other desired directions).

In some embodiments, the bonnet 15 and the valve seat 14 may be fixedly connected together by screws, or any other similar fastening mechanism. For example, as shown in FIGS. 5 and 7, the bonnet 15 and the valve seat 14 may be provided with corresponding screw holes 153, and the screws may be mounted in the screw holes 153 to connect the bonnet 15 and the valve seat 14. In this way, the mounting tightness of the screws may be adjusted to adjust the mounting tightness of the bonnet 15 on the valve seat 14 and, in turn, adjust the damping between the bonnet 15 and the assembly portion 132 and the damping between the assembly portion 132 and the scaling ring 144. It should be appreciated that, by adjusting the mounting tightness of the bonnet 15 and adjusting the damping between the bonnet 15 and the assembly portion 132, it may be possible to ensure that the movement resistance of the assembly portion 132 is not too great, which may make it difficult for a user to adjust the orientation of the water spray rod 133 and/or the orientation of the second water flow channel 131. In some embodiments, there may also be a plurality of screw holes 153 arranged at intervals around the assembly port 152 to improve the stability of the bonnet 15.

Referring still to FIGS. 6 and 7, the valve seat 14 may include a valve seat body 145 and a valve seat sleeve 146 that is connected to an outer surface of the valve seat body 145. In these embodiments, the valve chamber 141 may be formed in the valve scat body 145, and the bonnet 15 may be fixedly connected to the valve seat body 145. As further illustrated in FIGS. 6 and 7, the valve seat sleeve 146 and the water spray mat body 11 (or the water holding chamber 114) may be connected together in a sealing manner, such that contact between the valve seat sleeve 146 and the water spray mat body 11 forms a valve seat sleeve seal between the valve seat sleeve 146 and the water spray body 11.

In some embodiments, the valve seat sleeve 146 may be formed on the valve seat body 145 using a plastic coating process, such that the valve seat sleeve 146 and the valve seat body 145 are fixedly connected. In other embodiments, the valve seat body 145 may be made of ABS (i.e., acrylonitrile-butadiene-styrene) plastic, and the valve seat sleeve 146 may be made of PVC (i.e., polyvinyl chloride). In other embodiments still, the valve seat sleeve 146 and the valve seat body 145 may also be made of the same material.

In the embodiments described herein, the valve seat sleeve 146 and the water spray mat body 11 (or the water holding chamber 114) may be made of the same material (e.g., PVC). Accordingly, the valve seat sleeve 146 may be conveniently welded to the water spray mat body 11 (or the water holding chamber 114). However, it should be further appreciated that the valve seat sleeve 146 and the water spray mat body 11 (or the water holding chamber 114) may also be made of different materials without departing from the scope of the present disclosure. Furthermore, in some embodiments, the valve seat sleeve 146 may be fixed to the water spray mat body 11 (or the water holding chamber 114) by means of bonding, or any other similar process.

Referring again to FIGS. 6 and 7, the valve seat sleeve 146 may also be provided with an extension 147 that extends away from the valve seat body 145. In these embodiments, the extension 147 and the water spray mat body 11 (or the water holding chamber 114) may be connected together in a sealing manner (e.g., welded together), such that the contact between the extension 147 and the water spray mat body 11 forms an extension seal (e.g., weld, etc.). Accordingly, it should be appreciated that the area of connection between the extension 147 and the water spray mat body 11 (or the water holding chamber 114) may be large, which may aid in improving the stability of the water spray valve 12 on the water spray mat body 11.

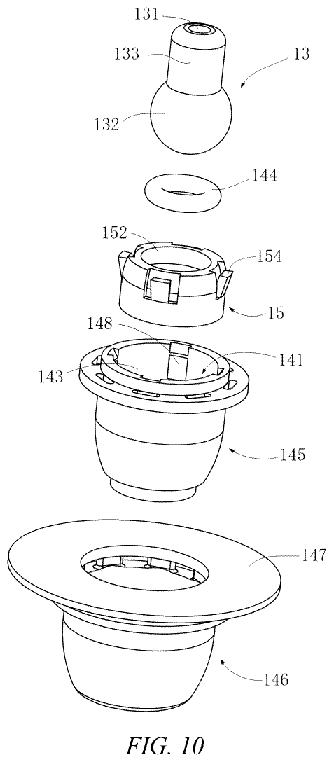

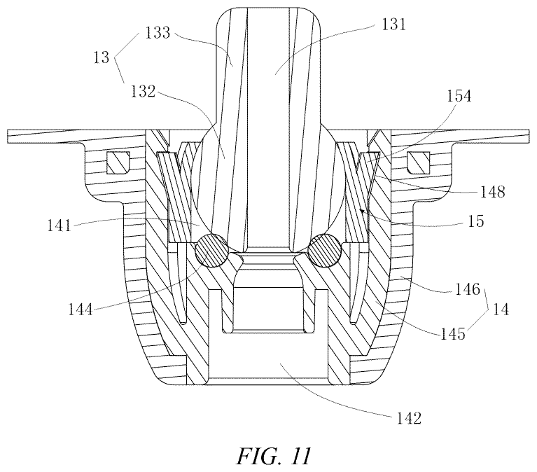

Referring now to FIG. 10, another embodiment of a water spray valve 12 is depicted. It should be appreciated that the structure of the water spray valve shown in FIG. 10 is similar to that of the water spray valve shown in FIG. 5. Accordingly, like structure is indicated with like reference numerals where possible. Furthermore, for the sake of simplicity, the following description focuses on the difference between the water spray valves.

As shown in FIGS. 10 and 11, the bonnet 15 may be provided with a plurality of elastic claws 154, and the valve seat 14 (or the valve seat body 145) may be provided with a plurality of engagement grooves 148 matching the plurality of elastic claws 154. Accordingly, by means of respectively snap-fitting the plurality of elastic claws 154 into the corresponding engagement grooves 148, the bonnet 15 may be fixedly mounted to the valve seat 14. It should be appreciated that the mounting method described herein is simple and convenient, and is conducive to improving the assembly efficiency of the water spray valve 12 (or the water spray mat 1). In addition, when the elastic claws 154 are snap-fitted into the engagement grooves 148, a “click” sound may be produced, such that an assembly operator can easily determine whether the bonnet 15 is mounted in place on the valve seat 14 according to the sound. It should be understood that the “click” sound generated by the snap-fit between the elastic claws and the engagement grooves 148 may further facilitate the assembly operation of the water spray valve 12 (or the water spray mat 1). It should also be understood that the clastic claws may also be provided on the valve seat 14, and correspondingly, the engagement grooves are provided on the bonnet 15.

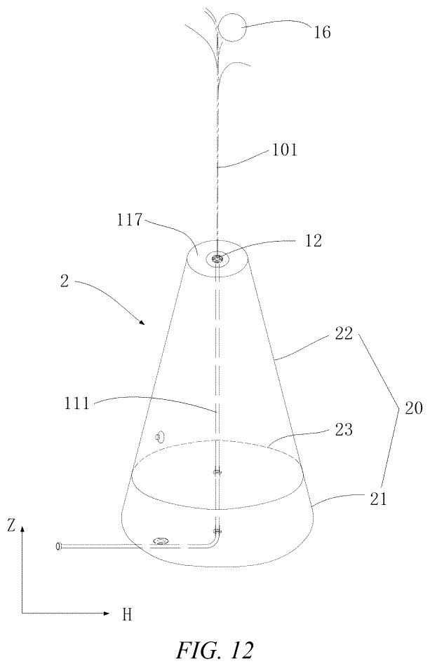

Turning now to FIG. 12, another embodiment of a water spray device is depicted. As shown in FIG. 12, the water spray device may be implemented as a water spray column 2. In these embodiments, the water spray column 2 may include a base 21 and an air chamber 22 located above the base 21, and the base 21 and the air chamber 22 may be spaced apart from each other by means of a spacer 23.

As further illustrated in FIG. 12, the base 21 and the air chamber 22 may form a water spray column body 20 (i.e., a device body). The water spray column 2 may further include a floating ball 16 and a water spray valve 12 that is arranged on a top wall 117 of the air chamber 22. The water spray valve depicted in FIG. 12 may be the same as the water spray valve depicted in FIGS. 1, 5 and 10.

Referring still to FIG. 12, the water spray column body 20 may be provided with a first water flow channel 111. In this embodiment, the first water flow channel 111 is configured as an independent water pipe. The first water flow channel 111 may extend through the base 21 and the spacer 23 into the air chamber 22, and may then be in communication (e.g., fluid communication) with a second water flow channel 131 of the water spray valve 12. Accordingly, water is supplied to the water spray valve 12 through the first water flow channel 111. The second water flow channel 131 of the water spray valve 12 spouts water in a vertically upward direction to form a first water jet 101 to support the floating ball 16.

In some embodiments, the base 21 may be configured as a water chamber adapted to be filled with water. In this way, filling the water chamber with water facilitates lowering the center of gravity of the water spray column 2, which is in turn conducive to improving the stability of the water spray column 2.

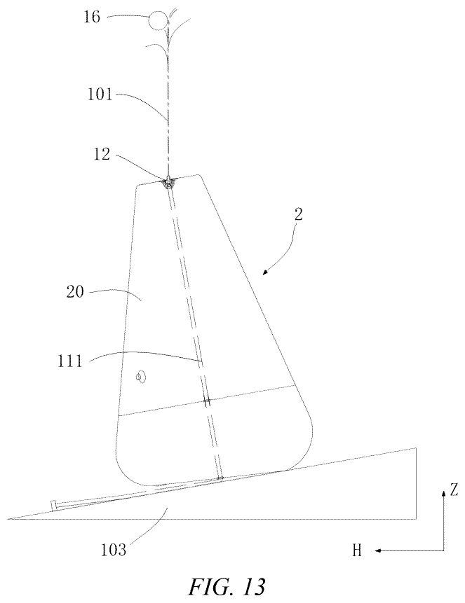

Furthermore, it should be appreciated that, when the water spray column 2 is arranged on a slope 103 (as shown in FIG. 13), the water spray nozzle 13 of the water spray valve 12 (and the second water flow channel 131) can be adjusted to be oriented in the vertical direction Z as needed, so that the first water jet 101 is in the vertically upward direction and supports the floating ball 16.

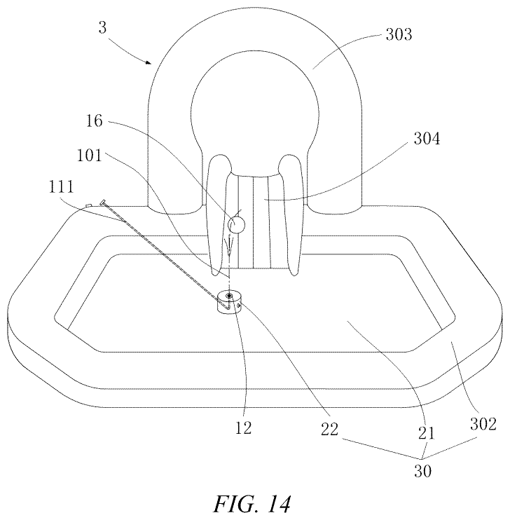

Turning now to FIG. 14, another embodiment of a water spray device is depicted. For example, in these embodiments, the water spray device may be provided in a pool 3. The pool 3 includes a pool body 30 (e.g., a device body), and the pool body 30 may include a base 21, a vertical barrier wall 302 arranged along a circumferential edge of the base 21, and an air chamber 22 protruding upwards from the base 21. Accordingly, it should be understood that a space enclosed by the base 21 and the vertical barrier wall 302 can be filled with water for a user to play in the water.

Furthermore, as depicted in FIG. 14, the air chamber 22 may be inflated to expand and protrude upwardly from the base 21. In these embodiments, the pool 3 further includes a floating ball 16 and a water spray valve 12 that is arranged on the air chamber 22. It should be appreciated that the water spray valve depicted in FIG. 14 is the same as the water spray valve depicted in FIGS. 1 and 5 described herein.

Referring still to FIG. 14, the base 21 may be provided with a first water flow channel 111. In this embodiment, the first water flow channel 111 may be configured as an independent water pipe. For example, the first water flow channel 111 may extend below the base 21 into the air chamber 22 and may be in communication (e.g., fluid communication) with a second water flow channel 131 of the water spray valve 12. In this way, water may be supplied to the water spray valve 12 through the first water flow channel 111. As has been described in detail herein, the water spray valve 12 spouts water in a vertically upward direction to form a first water jet 101, and the first water jet 101 then supports the floating ball 16.

In some embodiments, it should be appreciated that the air chamber 22 may also be filled with water. For example, the first water flow channel 111 may be in communication with the air chamber 22 to fill the air chamber 22 with water. Water in the air chamber 22 is vertically spouted upwards by the water spray valve 12 to form the first water jet 101, and the first water jet 101 then supports the floating ball 16. Furthermore, as depicted in FIG. 14, it should be understood that other facilities, such as an arch 303 and a slide 304, may also be provided on the pool body 30 to further improve the enjoyment of the pool 3.

The foregoing descriptions are only embodiments of the present disclosure and are not intended to limit the present disclosure. For those skilled in the art, various changes and variations can be made to the present disclosure. Any modifications, equivalent replacements, and improvements made without departing from the spirit and principle of the present disclosure shall fall within the scope of the claims of the present disclosure.

Furthermore, it should be apparent that the present disclosure is not limited to the details of the above-mentioned exemplary embodiments, and the present disclosure can be implemented in other specific forms without departing from the spirit or basic features of the present disclosure. Therefore, no matter from which point of view, the embodiments should all be regarded as exemplary and non-limiting. The scope of the present disclosure is defined by the appended claims rather than the above-mentioned description, and therefore it is intended that all changes which fall within the meaning and range of equivalents of the claims are embraced in the present disclosure. Any reference signs in the claims should not be construed as limiting the claims involved. In addition, it is apparent that the word “comprise/include” does not exclude other elements or steps, and the singular does not exclude the plural. The terms first, second, etc. are used for designations and do not represent any particular order.

It should be understood that the embodiments as shown in the drawings only show the optional shapes, sizes and arrangements of optional components of the sheet, laminated materials, and inflatable products according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that those skilled in the art would have made various variations and improvements to the concepts disclosed above under the creative idea of the present disclosure, and all the variations and improvements fall into the scope of protection of the present disclosure. The descriptions of the above embodiments are illustrative but not restrictive, and the scope of protection of the present disclosure is determined by the claims.

### PARTS LIST

1 Water spray mat
101 First water jet
102 Second water jet
103 Slope
11 Water spray mat body
111 First water flow channel
112 Water spray hole
113 Third water flow channel
114 Water holding chamber
115 Water source connection port
117 Top wall
12 Water spray valve
13 Water spray nozzle
131 Second water flow channel
132 Assembly portion
133 Water spray rod
134 First opening
135 Second opening
14 Valve seat
141 Valve chamber
142 Water intake port
143 Opening
144 Sealing ring
145 Valve seat body
146 Valve seat sleeve
147 Extension
148 Engagement groove
15 Bonnet
151 Cambered surface
152 Assembly port
153 Screw hole
154 Elastic claw
16 Floating ball
2 Water spray column
20 Water spray column body
21 Base
22 Air chamber
23 Spacer
3 Pool
30 Pool body
304 Slide
302 Vertical barrier wall
303 Arch
Z Vertical direction
H Horizontal direction

1. A water spray device comprising:
a device body comprising at least one first water flow channel;
at least one water spray valve comprising a water spray nozzle, the water spray nozzle defining a second water flow channel; and
at least one floating ball arranged adjacent to the water spray nozzle and adapted to be supported by water spouted from the second water flow channel of the water spray nozzle;
wherein the water spray nozzle is adapted to be adjusted to orient the second water flow channel in a vertical direction, the water spray valve is mounted to the device body, and the second water flow channel is in fluid communication with the first water flow channel.

2. The water spray device according to claim 1, wherein the water spray valve further comprises:
a valve seat that is provided with a valve chamber and a water intake port in communication with the valve chamber;
a first end of the valve chamber is provided with an opening, and the water intake port is located at a second end of the valve chamber that is offset from the first end.

3. The water spray device according to claim 2, wherein the water spray nozzle further comprises:
an assembly portion and a water spray rod extending from the assembly portion;
wherein the second water flow channel extends through the assembly portion and the water spray rod, the assembly portion is movably arranged inside the valve chamber, the water spray rod extends through the opening to the outside of the valve chamber, the second water flow channel is in communication with the water intake port, and the first water flow channel is in communication with the water intake port.

4. The water spray device according to claim 3, wherein the assembly portion has a spherical shape and is rotatably assembled in the valve chamber.

5. The water spray device according to claim 4, wherein a sealing ring is provided around the water intake port in the valve chamber, and the assembly portion forms a seal with the sealing ring.

6. The water spray device according to claim 4, wherein the water spray valve further comprises:
a bonnet having a cambered surface matching the spherical shape of the assembly portion and an assembly port corresponding to the opening;
wherein the bonnet is mounted to the valve seat, the cambered surface fits with the assembly portion to constrain the assembly portion within the valve chamber, and the water spray rod extends through the assembly port.

7. The water spray device according to claim 6, wherein one of the bonnet and the valve seat is provided with a plurality of elastic claws, and the other of the bonnet and the valve seat is provided with a plurality of engagement grooves matching the elastic claws.

8. The water spray device according to claim 7, wherein the plurality of elastic claws are adapted to be snap-fitted into the corresponding engagement grooves such that the bonnet is fixedly mounted to the valve seat.

9. The water spray device according to claim 6, wherein the bonnet and the valve seat are fixedly connected together by a screw.

10. The water spray device according to claim 2, wherein the valve seat further comprises:
a valve seat body; and
a valve seat sleeve connected to an outer surface of the valve seat body;
wherein the valve chamber is formed in the valve seat body, and the valve seat sleeve and the device body are connected together to form a valve seat sleeve seal.

11. The water spray device according to claim 10, wherein the valve seat sleeve is provided with an extension extending away from the valve seat body, and the extension and the device body are connected together to form an extension seal.

12. The water spray device according to claim 1, wherein the first water flow channel is provided with at least one water holding chamber, the water spray valve is mounted to a top wall of the water holding chamber in a sealing manner, and the second water flow channel is in communication with the inside of the water holding chamber.

13. The water spray device according to claim 12, wherein the water holding chamber protrudes upwardly from the device body.

14. The water spray device according to claim 1, wherein the device body comprises:
a base; and
an air chamber protruding upwardly from the base;
wherein the water spray valve is mounted to a top wall of the air chamber to form an air chamber seal; and the first water flow channel extends into the air chamber and is in communication with the second water flow channel of the water spray valve.

15. The water spray device according to claim 14, wherein the base is configured as a water chamber adapted to be filled with water, and the water chamber is separated from the air chamber.

16. The water spray device according to claim 1, wherein the water spray device is one of a water spray mat, a water spray column and a pool.

17. A pool comprising:
a pool body comprising:
a base;
a vertical barrier wall arranged along a circumferential edge of the base;
an air chamber protruding upwardly from the base; and
a first water flow channel extending below the base into the air chamber; and
a water spray valve comprising a water spray nozzle, the water spray nozzle defining a second water flow channel; and
at least one floating ball arranged adjacent to the water spray nozzle and adapted to be supported by water spouted from the second water flow channel of the water spray nozzle;
wherein the water spray nozzle is adapted to be adjusted to orient the second water flow channel in a vertical direction, the water spray valve is mounted to the air chamber, and the second water flow channel is in fluid communication with the first water flow channel.

18. The pool according to claim 17, wherein the water spray valve further comprises:
a valve seat that is provided with a valve chamber and a water intake port in communication with the valve chamber;
a first end of the valve chamber is provided with an opening, and the water intake port is located at a second end of the valve chamber that is offset from the first end.

19. The pool according to claim 18, wherein the water spray nozzle further comprises:
an assembly portion and a water spray rod extending from the assembly portion;
wherein the second water flow channel extends through the assembly portion and the water spray rod, the assembly portion is movably arranged inside the valve chamber, the water spray rod extends through the opening to the outside of the valve chamber, the second water flow channel is in communication with the water intake port, and the first water flow channel is in communication with the water intake port.

20. A water spray column comprising:
a base;
an air chamber located above the base;
a spacer that separates the base and the air chamber;
a first water flow channel extending through the base and the spacer into the air chamber;
a water spray valve comprising a water spray nozzle, the water spray nozzle defining a second water flow channel; and
at least one floating ball arranged adjacent to the water spray nozzle and adapted to be supported by water spouted from the second water flow channel of the water spray nozzle;
wherein the water spray nozzle is adapted to be adjusted to orient the second water flow channel in a vertical direction, the water spray valve is mounted to the air chamber, and the second water flow channel is in fluid communication with the first water flow channel.
